(19) United States
(12) Patent Application Publication
(10) Pub. No.: US 2002/0135584 A1
(43) Pub. Date: Sep. 26, 2002

(54) Video graphic adaptor for driving sub-monitor of dual monitor using usb port

(76) Inventor: Eun Seog Lee, Seoul (KR)

Correspondence Address: Morton J Rosenberg, Rosenberg Klein & Lee, Suite 101, 3458 Ellicott Center Drive, Ellicott City, MD, 21043, US

(21) Appl. No.: 09/890,255

(22) PCT Filed: Apr. 2, 2001
(86) PCT No.: PCT/KR01/00563

(30) Foreign Application Priority Data
Apr. 3, 2000 (KR) 2000-17266

(51) Int. Cl. G06T 1/00; G06F 15/00; G09G 5/39

(52) U.S. Cl. 345/531

(57) ABSTRACT

A video graphic adaptor (VGA) using a universal serial bus (USB) port for driving a sub-monitor in a dual monitor including a main monitor and a sub-monitor is provided. The VGA includes a first universal serial bus (USB) port outputting video data in a computer, a second USB port receiving the video data output from the first USB port, a video memory storing the video data input via the second USB port and outputting the stored video data, a random access memory digital-to-analog converter (RAMDAC) for converting the video data stored in the video memory into analog video data and outputting the converted result to the sub-monitor, a controller for controlling the video data input via the second USB port to be stored in the video memory, and then outputting the stored video data to the RAMDAC, and a video BIOS storing control data necessary for operation of the controller.

### TECHNICAL FIELD

The present invention relates to a video graphic adaptor for driving a sub-monitor of a dual monitor using a universal serial bus (USB) port, and more particularly, to a video graphic adaptor for driving a sub-monitor using a universal serial bus (USB) in a dual monitor which is comprised of a main monitor and a sub-monitor.

### BACKGROUND ART

In general, a computer includes a main board on which a CPU is mounted, a video graphic card, a sound card, an interface card, a storage device, an input device, and an output device such as a monitor and a printer.

The monitor is a device which enables a user to see predetermined images reproduced according to signals transmitted from the CPU and the video graphic card. A dual monitor used in the present invention includes a main monitor having a relatively wide display area and a sub-monitor having a relatively narrow display area in comparison with the main monitor.

The main monitor is configured by a 15.1-inch LCD panel and has a 1024×768 resolution, and a sub-monitor is configured by a 6.4-inch LCD panel and has a 640×480 resolution.

Thus, the main monitor should be driven by a high-performance VGA card in order to transmit video data for displaying a 1024×768 resolution and a 32-bit true color.

For this purpose, a PCI bus type VGA card has been widely used in the prior art, but an accelerated graphic port (AGP) VGA card is being widely used recently.

The AGP is a video graphic adaptor which is designed to have a transmission rate of 66-133 MHz by improving an existing PCI bus and to operate at a “no wait” mode, to thereby improve a data transmission rate between a main board and a graphic card greatly and thus efficiently process a large amount of video data.

However, the sub-monitor may transmit a relatively small amount of video data in comparison with the main monitor, and thus need not utilize a high-performance VGA.

Also, a single personal computer (PC) includes a single monitor basically, in which only a single accelerated graphic port (AGP) VGA port is set. Thus, a PCI type VGA should be used as another VGA which is necessary for connecting two or more monitors. In addition, in the case that there is no further PCI slots to be used, a VGA using an E-IDE slot should be used.

Most of PCs are provided with one AGP slot, three PCI slots, and one E-IDE slot.

Thus, when a scanner, a sound card and a LAN card are connected is connected in the PCI type slots, respectively, and a modem is connected in the E-IDE slot, the number of slots may lack in order to connect a separate VGA. As being the case, there may be no bus slot in the case when a user connects and uses other kinds of peripheral devices.

In order to solve the above problems, to monitors are connected by using a VGA having a dual output port. However, in this case, a separate dual output port VGA should be provided.

Also, if a high-performance VGA is used in order to drive a sub-monitor as described above, in comparison with display surroundings of the sub-monitor, the VGA performance and processing capacity may be wasted since the sub-monitor requires a relatively small amount of necessary data.

Thus, video data may be processed by using a USB port having a new standardized specification which can transmit a larger number of data in comparison with an existing serial port or parallel port. However, a video graphic adaptor for this purpose has not been developed commercially.

### DISCLOSURE OF THE INVENTION

To solve the above problems, it is an object of the present invention to provide a video graphic adaptor (VGA) for driving a sub-monitor in a dual monitor using a universal serial bus (USB) port, to thereby enhance an efficiency of using personal computers (PCs), in which the dual monitor includes a main monitor for displaying video data thereon and a sub-monitor for displaying a relatively smaller amount of video data thereon, which are connected to a single PC, respectively and a VGA using the USB port is used as the VGA for driving the sub-monitor.

To accomplish the above object of the present invention, there is provided a video graphic adaptor (VGA) for driving a sub-monitor having a relatively low resolution in comparison with a main monitor having a relatively high resolution, in which the sub-monitor VGA is connected to a main VGA in a computer for processing a relatively large amount of video data and outputting the processed video data, to thereby display video data thereon, the video graphic adaptor (VGA) comprising: a first universal serial bus (USB) port outputting video data in a computer; a second USB port receiving the video data output from the first USB port; a video memory storing the video data input via the second USB port and outputting the stored video data; a random access memory digital-to-analog converter (RAMDAC) for converting the video data stored in the video memory into analog video data and outputting the converted result to the sub-monitor; a controller for controlling the video data input via the second USB port to be stored in the video memory, and then outputting the stored video data to the RAMDAC; and a video BIOS storing control data necessary for operation of the controller.

The VGA according to the present invention further comprises a power supply for producing and supplying power necessary for operations of the controller, the video BIOS, the RAMDAC and the video memory. The power supply is an AC-DC converter for receiving separate external power and converting the same into power necessary for operations of the controller, the video BIOS, the RAMDAC and the video memory. Alternatively, the power supply is a DC-DC converter for receiving the power supplied from the first USB port in the computer via the second USB port and converting the received power into power necessary for operations of the controller, the video BIOS, the RAMDAC and the video memory.

The controller monitors the video data input via the second USB port and changes an operational mode of the sub-monitor into a standby mode by using the power supply, if new video data is not input for a predetermined time or more, to thereby perform a power saving function. Alternatively, the controller controls the power supply to stop the functions of operating the sub-monitor and the self-operation if the video data is not supplied from the computer, to thereby perform a power saving function.

Also, the controller, the video BIOS, the RAMDAC and the video memory are configured into a one-chip.

### BRIEF DESCRIPTION OF THE DRAWINGS

The above object and other advantages of the present invention will become more apparent by describing the preferred embodiments thereof in more detail with reference to the accompanying drawings in which:

FIG. 1 is a block diagram for explaining a video graphic adaptor (VGA) port for driving a sub-monitor in a dual monitor using a universal serial bus (USB) according to the present invention;

FIG. 2 is a block diagram for explaining a configuration of a USB VGA according to the present invention; and

FIG. 3 is a block diagram for explaining another configuration of a USB VGA according to the present invention.

### BEST MODE FOR CARRYING OUT THE INVENTION

A preferred embodiment of the present invention will be described below with reference to the accompanying drawings.

As peripheral devices are diversified in recent PC surroundings, the physical space of slots for connecting card type devices used in an existing PC surroundings and ports for connecting a printer, a mouse and so on has become insufficient. Further, a number of peripheral devices cannot be connected due to lack of IRQs necessary when peripheral devices are used in the PC surroundings. To solve the above problems, a new device connection method called a universal serial bus (USB) has been developed.

Peripheral devices can be easily connected with the USB via a hub from the exterior of a computer. The PC using the USB can be connected to one hundred twenty-seven peripheral devices at maximum. Also, peripheral devices can be designed based on a common interface provided by the USB, with a result that designers or developers can reduce burdens on new interface development and collision with existing peripheral devices, and support a plug and play (PnP) function more easily. Accordingly, users can install peripheral devices easily via a hub without opening the inside of the computers.

The USB having the above features has a channel speed of 12 Mbps and a sub-channel speed of 1.5 Mbps at maximum. The USB enables users to connect at maximum 127 peripheral devices to a computer, and the length of cable becomes 5m or so, which is a next-generation interface which can replace an existing serial/parallel port.

In particular, the USB can support a PnP function perfectly, so that users do not need set jumpers, IRQs, addresses and so on. Further, all peripheral devices can be connected by identical USB connectors and cables, and can be connected and disconnected freely from the computer even at the time when power is turned on irrespective of a sequence of connections. In addition, the connection sequence is automatically recognized in the bios and operating system in the PC, and thus the peripheral devices are automatically installed without requiring a separate installation work. That is, as soon as a peripheral device is fitted into a USB terminal, the system recognizes the identification data of the peripheral device, and as soon as the peripheral device is disconnected from the USB terminal, it is reported to the system that the peripheral device has been disconnected.

Moreover, since a maximum data transfer rate becomes 360-480 Mbps in the case of USB 2.0 which is a new USB specification, a sufficient data transfer rate is secured so that video data for a sub-monitor 34 can be processed as in the present invention.

Prior to describing a video graphic adaptor using a USB port having the above-described features for driving a sub-monitor in a dual monitor, according to the present invention, a dual monitor 30 employed in the present invention will be described below.

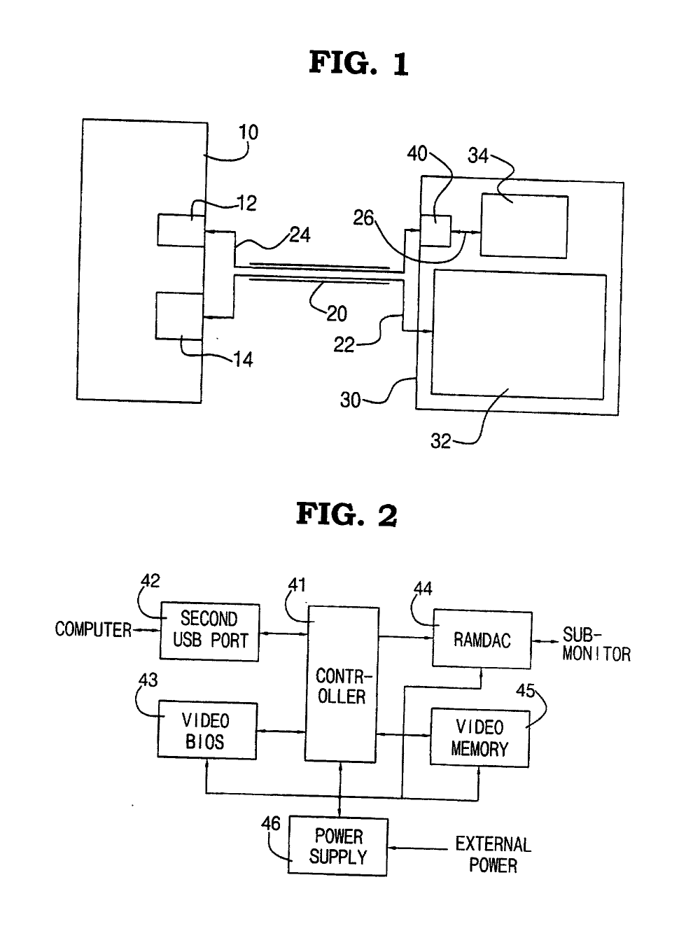

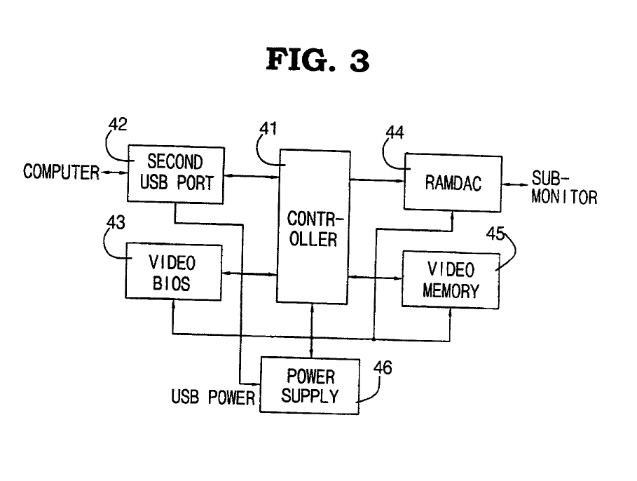

As shown in FIG. 1, a dual monitor includes a main monitor 32 configured by a 15.1-inch LCD panel and having a 1024×768 resolution, and a sub-monitor 34 configured by a 6.4-inch LCD panel and having a 640×480 resolution.

The main monitor 32 displays video data output by a main video graphic adaptor (VGA) 14 mounted on a computer 10, and the main VGA 14 is configured by an accelerated graphic port (AGP) VGA or a PCI VGA.

The sub-monitor 34 is driven by a USB VGA 40 for receiving the video data output via a first USB port 12 in the computer 10 and processing the received video data to then output the processed result.

Thus, a cable 20 connecting the computer 10 and the dual monitor 30 includes a main video cable 22 connecting the main VGA 14 and the main monitor 32, and a USB cable 24 connecting a first USB port 12 of the computer and a second USB port 42 of the USB VGA 40.

Also, the USB VGA 40 and the sub-monitor 34 are connected by a separately auxiliary video cable 26.

As shown in FIG. 2, the USB VGA 40 includes the second USB port 42 which is connected to the first USB port 12 of the computer 10 by the USB cable 24, for receiving video data, a video memory 45 storing the video data input via the second USB port 42 and outputting the stored video data, a random access memory digital-to-analog converter (RAMDAC) 44 for converting the video data stored in the video memory into analog video data and outputting the converted result to the sub-monitor 34, a controller 41 for controlling the video data input via the second USB port 42 to be stored in the video memory 45, and then outputting the stored video data to the RAMDAC 44, a video BIOS 43 for storing control data necessary for operation of the controller 41, and a power supply 46 for producing and supplying power necessary for operations of the controller 41, the video BIOS 43, the RAMDAC 44, and the video memory 45.

Here, the power supply 46 may be an AC-DC converter for receiving separate external power and converting the same into power necessary for operations of the components such as the controller 4, the video BIOS 43, the RAMDAC 44 and the video memory 45, to thereby supply the converted result to the components, or may be a DC-DC converter for receiving the power supplied from the first USB port 12 in the computer 10 via the second USB port 42 and converting the received power into power necessary for operations of the components, to thereby supply the converted result to the components.

In the case of the AC-DC converter receiving separate external power and converting the received power into an appropriate voltage thereby supplying the converted result to the components in order to be used as the operational voltages of the components as shown in FIG. 2, a sufficient power can be supplied, which thus does not cause any problems. However, the power of DC 5V voltage and 500 mA current at maximum supplied via the first USB port 12 of the computer 10 limits an amount of current which can be available stably into 100 mA. Accordingly, in the case that the power consumption of the components is larger than the limited value, inappropriate problems may happen.

Thus, a power supply system is determined considering the power consumption of the USB VGA 40.

Meanwhile, the controller 41 monitors the video data input via the second USB port 42 and changes an operational mode of the sub-monitor 34 into a standby mode by using the power supply 46, if new video data is not input for a predetermined time or more, to thereby perform a power saving function. Alternatively, the power supply 46 does not need to operate if the video data is not supplied from the computer 10, and the operational power is interrupted in order to make the USB VGA 40 as well as the sub-monitor 34 stop the operations thereof, to thereby perform a power saving function.

The above embodiment has been described with respect to the case that each chip set is used to configure the USB VGA 40. However, since the USB VGA 40 may be designed to perform only a particular function and to have a specification of processing a smaller amount of video data, the components which can be integrated together, for example, the controller 41, the video BIOS 43, the RAMDAC 44 and the video memory 45 are configured into a one-chip.

### INDUSTRIAL APPLICABILITY

As described above, the present invention realizes an auxiliary VGA for driving a sub-monitor by using a USB mode in a dual monitor including a main monitor having a relatively high resolution and a sub-monitor having a relatively low resolution, to thereby solve the problems of lacking in the number of the slots in the computer. Also, the present invention processes video data having a low resolution, so as to be embodied by a low-specification chip set.

As described above, the present invention has been described with respect to the above-described particularly preferred embodiment. However, the present invention is not limited in the above-described embodiment. It is apparent to one who is skilled in the art that there are many variations and modifications, without departing off the spirit of the present invention.

1. A video graphic adaptor (VGA) for driving a sub-monitor having a relatively low resolution in comparison with a main monitor having a relatively high resolution, in which the sub-monitor VGA is connected to a main VGA in a computer for processing a relatively large amount of video data and outputting the processed video data, to thereby display video data thereon, the video graphic adaptor (VGA) comprising:
a first universal serial bus (USB) port outputting video data in a computer;
a second USB port receiving the video data output from the first USB port;
a video memory storing the video data input via the second USB port and outputting the stored video data;
a random access memory digital-to-analog converter (RAMDAC) for converting the video data stored in the video memory into analog video data and outputting the converted result to the sub-monitor;
a controller for controlling the video data input via the second USB port to be stored in the video memory, and then outputting the stored video data to the RAMDAC; and
a video BIOS storing control data necessary for operation of the controller.

2. The video graphic adaptor of claim 1, further comprising a power supply for producing and supplying power necessary for operations of the controller, the video BIOS, the RAMDAC and the video memory.

3. The video graphic adaptor of claim 2, wherein said power supply comprises an AC-DC converter for receiving separate external power and converting the same into power necessary for operations of the controller, the video BIOS, the RAMDAC and the video memory.

4. The video graphic adaptor of claim 2, wherein said power supply comprises a DC-DC converter for receiving the power supplied from the first USB port in the computer via the second USB port and converting the received power into power necessary for operations of the controller, the video BIOS, the RAMDAC and the video memory.

5. The video graphic adaptor of any one of claims 1 through 4, wherein said controller monitors the video data input via the second USB port and changes an operational mode of the sub-monitor into a standby mode by using the power supply, if new video data is not input for a predetermined time or more, to thereby perform a power saving function.

6. The video graphic adaptor of any one of claims 1 through 4, wherein said controller controls the power supply to stop the functions of operating the sub-monitor and the self-operation if the video data is not supplied from the computer, to thereby perform a power saving function.

7. The video graphic adaptor of claim 1, wherein the controller, the video BIOS, the RAMDAC and the video memory are configured into a one-chip.
